(19) United States
(12) Patent Application Publication
(10) Pub. No.: US 2023/0163306 A1
(43) Pub. Date: May 25, 2023

(54) ELECTRODE FOR SECONDARY BATTERY AND MANUFACTURING METHOD OF ELECTRODE FOR SECONDARY BATTERY

(71) Applicant: PRIMEARTH EV ENERGY CO., LTD., Kosai-shi (JP)

(72) Inventors: Kazuki NAKANO, Toyohashi-shi (JP); Shotaro DEGUCHI, Toyohashi-shi (JP)

(21) Appl. No.: 18/056,223

(22) Filed: Nov. 16, 2022

(30) Foreign Application Priority Data
Nov. 24, 2021 (JP) 2021-190239

(51) Int. Cl. H01M 4/62; H01M 4/04; H01M 10/0525

(52) U.S. Cl. CPC H01M 4/625; H01M 4/0404; H01M 4/0471; H01M 10/0525

(57) ABSTRACT

An electrode for a secondary battery having high durability while reducing the internal resistance of the battery, and a method for manufacturing the electrode for a secondary battery are provided. An electrode for a secondary battery includes a current collecting foil including reactive functional groups on a front surface and a mixture layer formed on the front surface of the current collecting foil and including an active material, a binder, and carbon nanotubes including surface functional groups reactive with the reactive functional groups. More functional groups derived from the surface functional groups are present in the vicinity of the rear surface of the mixture layer than in the vicinity of the front surface of the mixture layer.

### CROSS-REFERENCE TO RELATED APPLICATION

The present application claims priority to Japanese Patent Application No. 2021-190239, filed on Nov. 24, 2021. The entire contents of the above-listed application are hereby incorporated by reference for all purposes.

### FIELD OF INVENTION

The present disclosure relates to an electrode for a secondary battery and a method for manufacturing the electrode for a secondary battery.

### BACKGROUND

Secondary batteries are widely used as portable power sources for personal computers, portable terminals, etc., and as power sources for driving vehicles. Among the secondary batteries, lithium-ion secondary batteries, which are light in weight and have high energy density, are suitably used as a high output power source for driving vehicles such as electric vehicles, hybrid vehicles, and plug-in hybrid vehicles. The lithium-ion secondary battery is a secondary battery which can be charged and discharged by the movement of lithium ions in an electrolyte between a positive electrode (a positive electrode plate) and a negative electrode (a negative electrode plate) for storing and discharging the lithium ions.

An electrode used in a secondary battery such as a lithium-ion secondary battery includes a conductive current collecting foil (current collector) and a mixture layer including an electrode material such as an active material, a conductive material, and a binder held on the current collecting foil. The carbon nanotubes are suitably used as a conductive material included in the electrode, because high conductivity can be ensured with a very small amount thereof.

Japanese Unexamined Patent Application Publication No. 2007-242386 discloses an electrode including at least a current collector, a conductive material, and an organic compound having a π-electron conjugated cloud as an active material. Japanese Unexamined Patent Application Publication No. 2007-242386 discloses that the conductive material of the electrode includes at least carbon nanotubes, and a power storage element using the electrode. The technique described in Japanese Unexamined Patent Application Publication No. 2007-242386 describes that since a good current collecting property can be ensured between the organic compound, which is the active material, and the conductive material, an amount of the conductive material can be greatly reduced, and thus reduced weight, high capacity, and high output of the electrode and the power storage device can be further achieved.

However, in the technique described in Japanese Unexamined Patent Application Publication No. 2007-242386, since a bonding force between the current collecting foil and the mixture layer is insufficient, it is necessary to add a certain amount or more of a binder to the mixture layer. The binder is added to the mixture layer in order to ensure the binding property between the current collecting foil and the mixture layer and to stably fix the electrode material such as the active material. On the other hand, since the binder itself hardly contributes to the electrochemical performance of the electrode, it is desirable to reduce the amount of the binder as much as possible in view of increasing the energy density of the electrode and lowering the internal resistance of the battery. Therefore, the technique described in Japanese Unexamined Patent Application Publication No. 2007-242386 has a problem that the internal resistance of the battery increases as the amount of binder used increases.

### SUMMARY

The present disclosure has been made to solve the problem of an increase in internal resistance as the amount of binder increases, and an object of the present disclosure is to provide an electrode for a secondary battery having high durability while reducing an internal resistance of the battery, and a method for manufacturing the electrode for a secondary battery.

In an example aspect, an electrode for a secondary battery including: a current collecting foil including reactive functional groups on a front surface; and a mixture layer formed on the front surface of the current collecting foil and including an active material, a binder, and carbon nanotubes including surface functional groups reactive with the reactive functional groups is described. In some aspects, a thickness direction orthogonal to the front surface of the current collecting foil, when an end face of the mixture layer in contact with the current collecting foil is defined as a rear surface and an end face opposite to the rear surface is defined as a front surface, more functional groups derived from the surface functional groups are present in the vicinity of the rear surface of the mixture layer than in the vicinity of the front surface of the mixture layer.

In another example aspect, a method for manufacturing an electrode for a secondary battery includes: coating a paste including an active material, a binder, carbon nanotubes including surface functional groups reactive with reactive functional groups, and a solvent on a front surface of a current collecting foil including the reactive functional groups on a front surface; and heating and drying the coated paste to cause the reactive functional groups to react with the surface functional groups to form a mixture layer.

According to the present disclosure, it is possible to provide an electrode for a secondary battery having high durability while reducing an internal resistance of the battery, and a method for manufacturing the electrode for a secondary battery.

The above and other objects and/or features of the present disclosure will become more fully understood from the detailed description given hereinbelow and the accompanying drawings which are given by way of illustration only, and thus are not to be considered as limiting the present disclosure.

### BRIEF DESCRIPTION OF THE FIGURES

FIG. 1 is a cross-sectional view showing an electrode for a secondary battery according to a first embodiment;

FIG. 2 schematically shows a bonding state among carbon nanotubes included in the electrode for a secondary battery shown in FIG. 1 and a current collecting foil;

FIG. 3 is a flowchart showing a method for manufacturing the electrode for a secondary battery according to the first embodiment;

FIG. 4 is a graph showing a relationship between a ratio of a binder included in the various electrode plates and a peeling strength;

FIG. 5 is a graph showing a relationship between a ratio of the binder included in the various electrode plates and a direct current internal resistance;

FIG. 6 is a table showing the results of examining an effect of drying conditions on the peeling strength of the current collecting foil from the mixture layer constituting the electrode plate;

FIG. 7 is a cross-sectional view for explaining a method for determining the amount of functional groups present in the vicinity of the front and rear surfaces of the mixture layer; and

FIG. 8 is a table showing the results of examining the amount of functional groups present near the front and rear surfaces of the mixture layer.

### DETAILED DESCRIPTION

### First Embodiment

Embodiments of the present disclosure will now be described with reference to the drawings. However, the present disclosure is not limited to the following embodiments. In order to clarify the description, the following description and drawings are appropriately simplified.

As one embodiment of an electrode for a secondary battery according to this embodiment, an electrode for a lithium-ion secondary battery will be specifically described. A lithium-ion secondary battery is a secondary battery that is charged and discharged by lithium ions as charge carriers conducting in an electrolysis solution between a positive electrode (a positive electrode plate) and a negative electrode (negative electrode plate) in an electrochemical reaction. Such a lithium-ion secondary battery is suitably used as a power source for a vehicle such as an electric vehicle (EV), a hybrid vehicle (HV), or a plug-in hybrid vehicle (PHEV), among other uses.

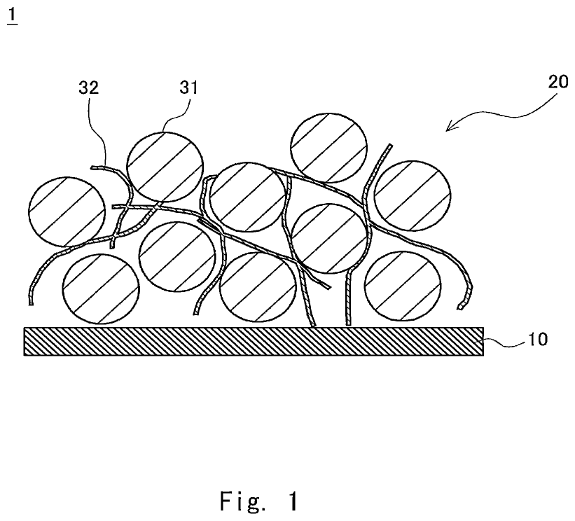

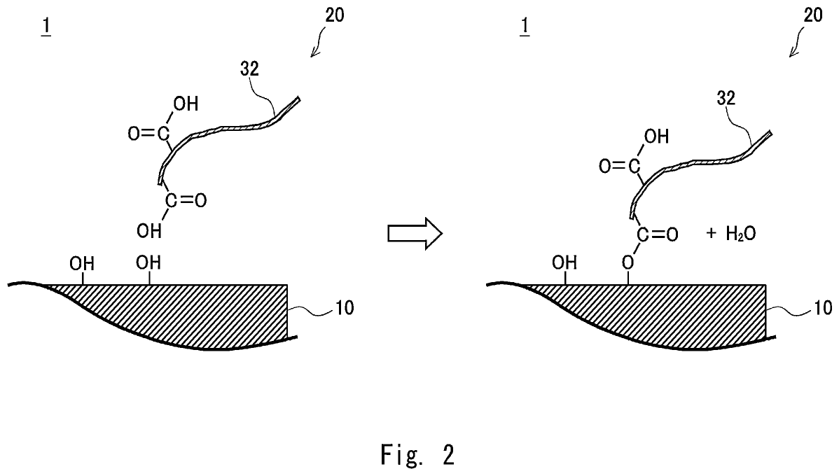

The structure of the secondary battery electrode (an electrode plate 1) according to this embodiment will be described with reference to FIGS. 1 and 2. FIG. 1 is a cross-sectional view showing an electrode for a secondary battery according to the first embodiment. FIG. 2 schematically shows a bonding state between carbon nanotubes included in the secondary battery electrode shown in FIG. 1 and a current collecting foil. The cross-sectional view shown in FIG. 1 shows a part of the cross-sectional view of the electrode plate 1 orthogonal to a surface of a current collecting foil 10. FIG. 2 is an enlarged view of the vicinity of the front surface of the current collecting foil 10. As shown in FIGS. 1 and 2, the electrode plate 1 includes the current collecting foil 10 and a mixture layer 20 formed on the front surface of the current collecting foil 10.

The current collecting foil 10 is a porous body such as a plate, a foil, or a mesh. The current collecting foil 10 has a thickness of, for example, 5 μm to 20 μm. The current collecting foil 10, before the mixture layer 20 is formed, has reactive functional groups on its front surface. The current collecting foil 10 is made of a metal having good conductivity or an alloy thereof. The current collecting foil 10 is not particularly limited as long as it has reactive functional groups on its front surface and may have functional groups other than the reactive functional groups on its front surface. Examples of the metal constituting the current collecting foil 10 include aluminum, copper, nickel, titanium, iron, stainless steel, and the like.

The reactive functional group is a functional group which can be chemically bonded to a surface functional group of a carbon nanotube 32 (CNT) described later. The reactive functional group may be a functional group such as a hydroxyl group (—OH) capable of reacting with the surface functional group of the CNT 32 to form a covalent bond under a heated environment. Such reactive functional groups may be present only on one side or on both sides of the current collecting foil 10.

In the case of the positive electrode plate 1, the metal constituting the current collecting foil 10 may be aluminum or an aluminum alloy. In the case of the negative electrode plate 1, the metal constituting the current collecting foil 10 may be copper or a copper alloy.

The mixture layer 20 is formed on at least one front surface of the current collecting foil 10 except an edge part along one edge in the width direction. In this embodiment, in regard to both end surfaces of the mixture layer 20 in the thickness direction perpendicular to the surface of the current collecting foil 10, the end surface in contact with the current collecting foil 10 is the rear surface of the mixture layer 20, and the end surface opposite to the rear surface is the front surface of the mixture layer 20. Further, the electrode plate 1 has an exposed part where the mixture layer 20 is not formed. For example the current collecting foil 10 is exposed at the edge part. The exposed part is electrically connected to an external terminal.

The mixture layer 20 includes at least an active material 31 capable of storing and releasing lithium ions, the CNTs 32 as a conductive material, and a binder. The mixture layer 20 is held by the current collecting foil 10. In this embodiment, the mixture layer 20 includes the CNTs 32 bonded to the front surface of the current collecting foil 10. Thus, the binding property between the current collecting foil 10 and the mixture layer 20 can be ensured. The mixture layer 20 may include other conductive materials (e.g., acetylene black, graphite, graphene, carbon black) other than the CNTs 32 or other additives (e.g., thickeners, dispersants), if necessary.

In the case of the positive electrode plate 1, a density of the mixture layer 20 is, for example, preferably 2.0 g/cm³ to 3.0 g/cm³, more preferably 2.2 g/cm³ to 2.8 g/cm³, and particularly preferably 2.4 g/cm to 2.6 g/cm³. In the case of the negative electrode plate 1, the density of the mixture layer 20 is, for example, preferably 1.0 g/cm³ to 1.8 g/cm³, more preferably 1.05 g/cm³ to 1.6 g/cm³, and particularly preferably 1.1 g/cm³ to 1.4 g/cm³.

In the case of the positive electrode plate 1, the thickness of the mixture layer 20 may be, for example, preferably 15 μm to 50 μm, more preferably 18 μm to 40 μm, and particularly preferably 20 μm to 30 μm. In the case of the negative electrode plate 1, the thickness of the mixture layer 20 may be, for example, preferably 20 μm to 60 μm, more preferably 25 μm to 50 μm, and particularly preferably 30 μm to 40 μm.

In the case of the positive electrode plate 1, as the active material 31, lithium cobaltate (LiCoO₂), lithium nickelate (LiNiO₂), lithium manganate (LiMn₂O₄), lithium iron phosphate (LiFePO₄), lithium nickel cobalt aluminate (NCA), lithium nickel cobalt manganate (NCM), and the like may be used alone or in combination. Other metal elements may be added to the active material 31.

In the case of the negative electrode plate 1, natural graphite, artificial graphite, hard carbon, soft carbon, graphite, tin (Sn), tin oxide (SnO), silicon (Si), silicon oxide (SiO), lithium titanate (Li₄Ti₅O₁₂) and the like may be used as the active material 31.

For example, since the active material 31 suitably used for the positive electrode tends to have low conductivity, the effect of reducing a resistance by adding the CNTs 32 is high. Therefore, the structure of the electrode for a secondary battery according to this embodiment is suitable for the positive electrode plate 1.

As the CNTs 32 used as the conductive material, for example, single-walled carbon nanotubes, two-walled carbon nanotubes, multi-walled carbon nanotubes of three or more layers, and the like may be used. The CNT 32 may be manufactured by an arc discharge method, a laser ablation method, a chemical vapor deposition method, or the like. The CNTs 32 manufactured by these methods can be used alone or in combination.

The CNTs 32 form a conductive path among the particles of the active material 31 and between the active material 31 and the current collecting foil 10, and has a function of improving the conductivity of the entire electrode. In addition, the CNTs 32 can connect the particles of the active material 31 to each other by their fiber lengths, thereby improving the binding property among the particles of the active material 31. On the other hand, if the fiber length of the CNT 32 is too long, the CNT 32 tends to agglomerate, thereby decreasing the dispersibility, so that it becomes difficult to obtain the effect of improving the conductivity and the binding property.

In terms of conductivity, mechanical properties, and dispersibility, the average fiber length of the CNT 32 may be, for example, preferably 0.1 to 100 μm, and more preferably from 0.3 μm to 20 μm. In terms of flexibility and dispersibility, the average outer diameter of the CNT 32 may be, for example, preferably 3.0 nm to 50 nm, and more preferably 5.0 nm to 20 nm.

The CNTs 32 before the mixture layer 20 is formed has surface functional groups on its front surface. A surface functional group is a functional group which can be chemically bonded to the reactive functional group of the current collecting foil 10. Exemplary surface functional groups are functional groups such as a hydroxyl group or a carboxy group (—COOH) capable of forming a covalent bond by dehydration condensation reaction with the reactive functional group of the current collecting foil 10.

The amount of the surface functional groups may be set within a range that does not impair the conductivity, mechanical properties, and dispersibility of the CNTs 32, while having good binding property with the current collecting foil 10. The amount of the surface functional groups present on the front surface of the CNT 32 may be preferably 0.1 mass % to 30 mass %, more preferably 0.5 mass % to 15 mass %, and particularly preferably 1.0 mass % to 5.0 mass % based on the mass of the CNTs 32.

The amount of the surface functional groups present on the front surface of the CNTs 21 may be increased by subjecting the CNTs 32 to a surface treatment to thereby introduce the surface functional groups into the CNTs 32. The surface functional group may be a carboxy group as the amount used can be easily increased.

The binder binds the electrode materials constituting the mixture layer 20 to each other and binds the formed mixture layer 20 on the front surface of the current collecting foil 10. Exemplary binders, for example, polyvinylidene fluoride (PVdF), polyethylene oxide (PEO), polyethylene oxide (PEO), styrene-butadiene rubber (SBR), butyl rubber (BR) and the like may be used. In the case of the positive electrode plate 1, PVdF may be used. In the case of the negative electrode plate 1, SBR may be used.

The ratio of the active material 31 to the entire mixture layer 20 may be, for example, preferably from 94.0 to 99.8 mass %, more preferably from 96.5 to 99.4 mass %, and particularly preferably from 97.8 to 99.0 mass %, in view of achieving high power characteristics and high energy density.

The ratio of the CNTs 32 to the entire mixture layer 20 may be, for example, preferably 0.1 to 3.0 mass %, more preferably 0.3 to 1.5 mass %, and particularly preferably 0.5 to 1.2 mass %. By using the CNTs 32 as the conductive material, the ratio of the conductive material to the entire mixture layer 20 can be reduced, so that the ratio of the active material 31 to the entire mixture layer 20 can be relatively increased.

The ratio of the binder to the entire mixture layer 20 may be, for example, preferably 0.1 to 3.0 mass %, more preferably 0.3 to 2.0 mass %, and particularly preferably 0.5 to 1.0 mass %. In this embodiment, at least some of the CNTs 32 included in the mixture layer 20 are chemically bonded to the front surface of the current collecting foil 10, thereby improving the bonding force between the current collecting foil 10 and the mixture layer 20, so that the ratio of the binder to the entire mixture layer 20 can be reduced.

Therefore, a desired peeling strength and output characteristics can be achieved without an increase in resistance. In addition, since the amount of each of the conductive material and the binder can be reduced to a small amount, the amount of the active material 31 can be increased, increasing the energy density of the electrode plate 1.

Since at least some of the CNTs 32 included in the mixture layer 20 are chemically bonded to the front surface of the current collecting foil 10, the electrode plate 1 includes functional groups derived from the surface functional groups. The functional group derived from the surface functional group is at least one of a functional group formed by bonding the surface functional group and the reactive functional group to each other and an unreacted surface functional group. In the electrode plate 1, more functional groups derived from the surface functional groups are present near the rear surface of the mixture layer 20 than near the front surface of the mixture layer 20.

That is, when the vicinity of the front surface of the mixture layer 20 is defined as a front part and the vicinity of the rear surface of the mixture layer 20 is defined as a rear part, the front part includes at least unreacted surface functional groups, and the rear part includes at least the generated functional groups and unreacted surface functional groups. Thus, the rear part includes more functional groups derived from the surface functional groups than the front part. The front part and the rear part are, for example, layers having a thickness of about 3 μm from the front surface or the rear surface of the mixture layer 20.

For example, the amount of the functional groups included in the rear part (the amount of the functional groups derived from the surface functional groups) may be 1.3 times or more, or 1.6 times or more, of the amount of the functional groups included in the front part. By setting the ratio of the amount of the functional groups in the rear part to the amount of the functional groups in the front part to the ratios described above, the electrode plate 1 having the good binding property between the current collecting foil 10 and the mixture layer 20 can be obtained while reducing the amount of the binder used. The above ratio is particularly effective when the ratio of the CNTs 32 to the entire mixture layer 20 is 0.1 to 3.0 mass % and the ratio of the surface functional groups to the mass of the CNTs 32 is 0.1 to 30 mass %.

In the example shown in FIG. 2, at least some of the hydroxyl groups provided on the front surface of the current collecting foil 10 and at least some of the carboxy group provided on the surface of the CNTs 32 undergo a dehydration condensation reaction to form an ester bond. Thus, since the current collecting foil 10 and the CNTs 32 are firmly bonded, the electrode plate 1 having excellent peeling strength of the current collecting foil 10 from the mixture layer 20 can be obtained. Furthermore, as shown in FIG. 2, a carboxy group and a carbonyl group (>C═O) derived from the surface functional groups coexist in the vicinity of the current collecting foil 10 of the electrode plate 1 and in the rear part of the mixture layer 20.

Furthermore, the electrode plate 1 having the above-described structure can constitute a lithium-ion secondary battery by combining an electrolyte including lithium ions with an insulating separator through which lithium ions can pass if necessary.

The electrolyte may be, for example, a nonaqueous electrolysis solution. The nonaqueous electrolysis solution is a composition in which a lithium salt is dissolved in an organic solvent. LiClO₄, LiPF₆, LiAsF₆, LiBF₄, LiSO₃CF₃ or the like may be used as the lithium salt. Examples of the organic solvent include cyclic carbonates such as ethylene carbonate, propylene carbonate, butylene carbonate, and trifluoropropylene carbonate, chain carbonates such as diethyl carbonate, dimethyl carbonate, ethyl methyl carbonate, and dipropyl carbonate, ether compounds such as tetrahydrofuran, 2-methyl tetrahydrofuran, and dimethoxyethane, sulfur compounds such as ethyl methyl sulfone and butanesultone, and phosphorus compounds such as triethyl phosphate and trioctyl phosphate. The organic solvent may be used alone or in combination with a plurality of the organic solvents.

The separator is composed of a porous insulating resin sheet such as polyethylene (PE) or polypropylene (PP). Such a porous resin sheet may have a single layer structure or a laminated structure of two or more layers. Further, a porous heat-resistant layer may be provided on a part of the front surface of the resin sheet.

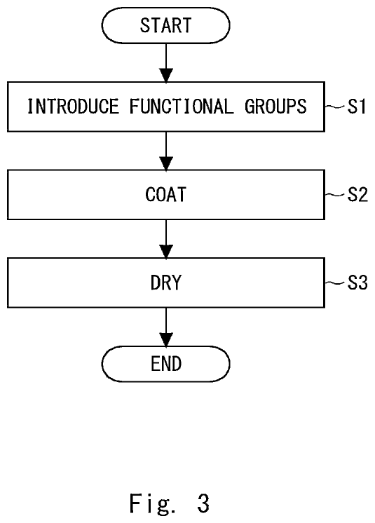

Next, a method for manufacturing the electrode for a secondary battery according to this embodiment will be described with reference to FIG. 3. FIG. 3 is a flowchart showing a method for manufacturing the electrode for a secondary battery according to the first embodiment. In the following description, the method for manufacturing the electrode for a secondary battery according to this embodiment can be applied to manufacturing the electrode plates 1 of both the positive electrode and the negative electrode.

As shown in FIG. 3, the method for manufacturing the electrode for a secondary battery according to this embodiment has the following steps S1 to S3. Step S1 is a functional group introduction step of increasing the amount of at least one of the surface functional groups and the reactive functional groups by subjecting at least one of the CNTs 32 and the current collecting foil 10 to a surface treatment. Step S2 is a coating step of coating a paste including the active material 31, the binder, the CNTs 32 having surface functional groups reactive with the reactive functional groups, and a solvent on the front surface of the current collecting foil 10 having the reactive functional group on the front surface. Step S3 is a drying step of heating and drying the coated paste to react the reactive functional groups with the surface functional groups to form the mixture layer 20. Each of the above steps will be described in more detail below.

First, examples of the method for introducing the reactive functional groups into the current collecting foil 10 in the functional group introduction step include surface modification by various plasma treatments such as atmospheric pressure plasma treatment, vacuum plasma treatment, and corona discharge treatment. For example, hydroxyl groups can be introduced into the front surface of the current collecting foil 10 by an atmospheric pressure plasma treatment in which plasma using oxygen gas as a plasma generating gas is applied under atmospheric pressure.

An example of a method for introducing the surface functional groups into the CNTs 32 includes surface oxidation by an acid treatment using a strong acid. For example, carboxy groups can be introduced into the front surface of the CNTs 32 by immersing the CNTs 32 as a raw material in a mixed acid of sulfuric acid and nitric acid and then heating it.

The method for introducing the reactive functional groups or the surface functional groups is not limited to the above-described method, and other known methods may be employed. The amount and structures of the reactive functional groups provided on the front surface of the current collecting foil 10 and the surface functional groups provided on the front surface of the CNTs 32 can be confirmed, for example, by X-ray photoelectron spectroscopy (XPS). If the obtained current collecting foil 10 and CNTs 32 each have a desired amount of reactive functional groups or surface functional groups, the functional group introduction step may be omitted.

Next, in the coating step, a solvent is added to a powder including the active material 31, the CNTs 32, the binder, and other additives as necessary, and these are kneaded to prepare a paste for forming the mixture layer. For kneading these electrode materials, a suitable mixer such as a planetary mixer may be used.

The solvent is appropriately selected in consideration of the binder to be used and the dispersibility of the CNTs 32 in the solvent. A non-aqueous solvent such as N-methyl-2 pyrrolidone (NMP), methyl ethyl ketone (MEK), dimethylformamide (DMF), toluene, a mixed solvent in combination with a non-aqueous solvent, water, an aqueous solvent mainly consisting of water, or the like may be used.

The prepared paste is then coated on the front surface of the current collecting foil 10. The paste can be coated using a suitable coating apparatus such as a die coater, a comma coater, a knife coater, a gravure coater or the like.

Next, in the mixture layer forming step, the coated paste is heated and dried under a predetermined drying condition to remove the solvent included in the paste. In this step, a dehydration condensation reaction between the reactive functional groups and the surface functional groups proceeds. When the solvent is, for example, NMP (boiling point: 202° C.), the coated paste may be heated and dried at a temperature of 150° C. or less for 100 seconds or longer. The drying condition can be appropriately changed according to the type of the solvent used and the amount of the solvent used, and the drying condition may be such that the solvent volatilizes over time.

For the heating and drying method, a method using a hot air dryer, an infrared heater, a far-infrared heater, or the like may be used. Further, the dried material is pressed as necessary to form the mixture layer 20 on the front surface of the current collecting foil 10. The electrode plate 1 shown in FIG. 1 can be manufactured through the above steps.

Next, further details of the present disclosure will be described based on embodiments. Embodiments are not intended to limit the present disclosure.

### Preparation of Positive Electrode Plate and Evaluation of Peeling Strength

First, according to the flow diagram shown in FIG. 3, the positive electrode plate 1 was manufactured. As the positive electrode active material (the active material 31), a nickel manganese cobaltate lithium (NMC) having an average composition represented by LiNi_{1/3}Co_{1/3}Mn_{1/3}O₂ was used. As the CNTs 32, either one of the CNTs 32 (acid-treated CNTs) subjected to an acid treatment in the functional group introduction step or CNTs 32 (non-acid treated CNTs) not subjected to an acid treatment by omitting the functional group introduction step was used. The CNTs 32 includes carboxy groups as the surface functional groups. PVdF was used as the binder. NMP was used as the solvent.

The NCM, CNTs 32, and PVdF were weighed in various mass ratios, added with a required amount of solvent, and kneaded to prepare a paste for forming the positive electrode mixture layer. When the acid-treated CNTs were used and when the non-acid treated CNTs were used, respectively, the mass ratio was adjusted so that the total amount was 100 mass % by setting the ratio of the CNTs 32 to 1.0 mass %, increasing or decreasing the ratio of PVdF within the range of 0.5 to 2.0 mass %, and setting the balance to NCM.

Next, each of the prepared pastes for forming the positive electrode mixture layer was coated to one surface of the aluminum foil, which is the current collecting foil 10 of the positive electrode. The aluminum foil includes hydroxyl groups as the reactive functional groups. The coating amount of the paste for forming the positive electrode mixture layer was adjusted so that the weight amount became 6 mg/cm². Then, the respective coated pastes were dried under the drying condition by hot air at 150° C. for 120 seconds, and after drying, pressing was performed to prepare the respective positive electrode plates. Each of the prepared positive electrode plates had a density of 2.5 g/cm³ and a thickness of 35 μm. In this way, nine types of positive electrode plates were obtained. In each of the positive electrode plates, the mixture layer 20 including the binder at a ratio of 0.5 to 2.0 mass % was formed.

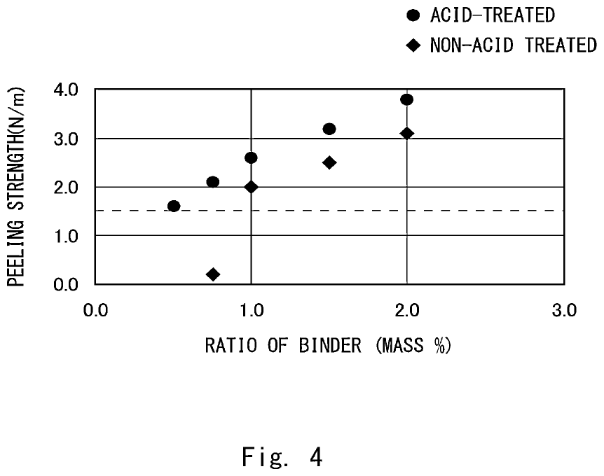

The peeling strength of the positive electrode plate thus obtained was evaluated. FIG. 4 is a graph showing the relationship between the ratio of the binder included in the various electrode plates and the peeling strength. The horizontal axis of FIG. 4 shows the ratio (mass %) of the binder included in the mixture layer 20, and the vertical axis shows the peeling strength (N/m). Circular plots in the graph of FIG. 4 indicate positive electrode plates using acid-treated CNTs, and rhombic plots indicate positive electrode plates using non-acid treated CNTs.

The peeling strength was evaluated by a 180 degree peeling test method using a tensile testing machine in accordance with JIS Z0237: 2009. Specifically, a double-sided tape of a predetermined size was stuck on a steel plate, and the mixture layer 20 cut to a width of 10 mm×a length of 150 mm was brought into close contact with the opposite surface of the double-sided tape, and was peeled while being pulled in the direction of 180° at a speed of 40 mm/min. An average value of the stress at this time was used as the peeling strength (N/m).

As a result of measuring the peeling strength in this way, the peeling strength of the positive electrode plate using the non-acid treated CNTs decreased as the ratio of the binder decreased, and in particular, the peeling strength significantly decreased when the ratio of the binder was less than 1.0 mass %.

On the other hand, the positive electrode plate using the acid-treated CNT showed a higher level of peeling strength than that of the positive electrode plate using the non-acid treated CNTs, although the peeling strength decreased as the ratio of binder decreased. In the case of the positive electrode plate using the acid-treated CNTs, for example, when the ratio of the binder is 0.5 mass %, which is less than 1.0 mass %, the peeling strength was 1.7 N/m, and thus a peeling strength more than the peeling strength required for manufacturing can be ensured. In this embodiment, the peeling strength required for manufacturing is the peeling strength of 1.5 N/m or more indicated by a broken line in the graph of FIG. 4.

While not wishing to be bound, it is considered that the reason why such a result was obtained is that the amount of the surface functional groups of the CNTs 32 bonded to the reactive functional groups of the current collecting foil 10 increased with the increase in the amount of the surface functional groups of the CNTs 32 by the acid treatment, resulting in the improvement of the binding property between the current collecting foil 10 and the mixture layer 20.

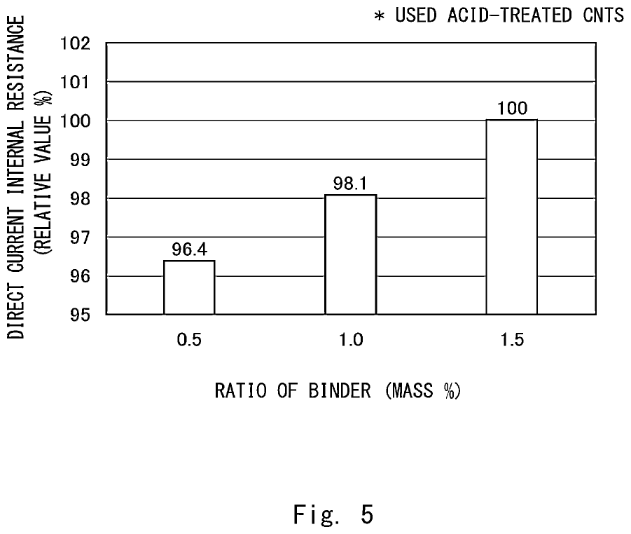

Next, the effect of the amount of the binder on the battery performance was studied with reference to FIG. 5. FIG. 5 is a graph showing the relationship between the ratio of the binder included in the various electrode plates and the direct current internal resistance. FIG. 5 shows the result of evaluating the direct current internal resistance of three types of battery cells for evaluation constructed to evaluate battery performance.

### Construction of Battery Cell for Evaluation and Battery Performance Evaluation

The three types of battery cell for evaluations are the positive electrode plates using acid treated CNTs among the positive electrode plates described with reference to FIG. 4. The three types of battery cell for evaluations are lithium-ion secondary batteries constructed using three types of positive electrode plates which are formed with mixture layers 20 including a binder at ratios of 0.5 mass %, 1.0 mass % and 1.5 mass %, respectively. Each battery cell for evaluation was constructed by the following procedure using these three types of positive electrode plates.

First, the negative electrode plate was prepared as follows: natural graphite (C) was used as the negative electrode active material, carboxymethyl cellulose (CMC) was used as the thickener, SBR was used as the binder, and ion exchange water was used as the solvent.

A paste for forming a negative electrode mixture layer was prepared by weighing the negative electrode active material, the thickener, and the binder in a mass ratio of C:CMC:SBR=98:1:1, adding a required amount of solvent, and kneading them. Next, the prepared paste for forming the negative electrode mixture layer was coated on one side of a copper foil as the current collecting foil of the negative electrode. The coating amount of the paste for forming the negative electrode mixture layer was adjusted so that the coating amount became 4 mg/cm². Then, the coated paste was dried under the drying condition by hot air at 150° C. for 120 seconds, and after drying, pressing was performed to prepare the negative electrode plate. The prepared negative electrode plate had a density of 1.2 g/cm³ and a thickness of 45 μm.

A support salt LiPF₆ was dissolved at a concentration of 1 mol/L in a mixed solvent as an electrolysis solution obtained by mixing ethylene carbonate (EC), dimethyl carbonate (DMC) and ethyl methyl carbonate (EMC), so that the volume ratio thereof became 1:1:1.

Then, the mixture layer 20 of the positive electrode plate and the mixture layer of the negative electrode plate thus prepared were made to face each other, and an electrode body laminated with a separator made of PE interposed therebetween was housed inside an exterior material made of aluminum laminate and was sealed by adding an electrolysis solution thereto. In this manner, a laminated battery cell for evaluation is constructed.

FIG. 5 shows evaluation results obtained by measuring the direct current internal resistance (DCIR) of the constructed three types of battery cells for evaluation. FIG. 5 is a graph showing the relationship between the ratio of the binder included in the various electrode plates and the direct current internal resistance. The vertical axis of FIG. 5 shows a relative value of the direct current internal resistance, where the direct current internal resistance (Ω) of the battery cell for evaluation including a positive electrode plate having a binder ratio of 1.5 mass % is 100%. The lower the percentage value indicating the relative value of the direct current internal resistance, the more likely it is that the increase in resistance is reduced.

The direct current internal resistance was measured by adjusting the various battery cells for evaluation that had undergone initial charging and discharging to a State of Charge (SOC) of 60%, discharging them at 5 C for 10 seconds in a temperature environment of 25° C., and then measuring the amount of voltage change before and after the discharge. The direct current internal resistance was calculated as the average value of the value obtained by dividing the voltage change amount by the current value.

As shown in FIG. 5, the direct current internal resistance decreased by 1.9% in the battery cell for evaluation including a positive electrode plate having a binder ratio of 1.0 mass % compared with the battery cell for evaluation including a positive electrode plate having a binder ratio of 1.5 mass %. Further, the direct current internal resistance was reduced by 5.6% in the battery cell for evaluation including a positive electrode plate having a binder ratio of 0.5 mass % compared with the battery cell for evaluation including a positive electrode plate having a binder ratio of 1.5 mass %. As can be seen from the results, it was confirmed that the ratio of the binder can be reduced by using the acid treated CNTs 32, and that the internal resistance of the battery decreased as the ratio of the binder is reduced.

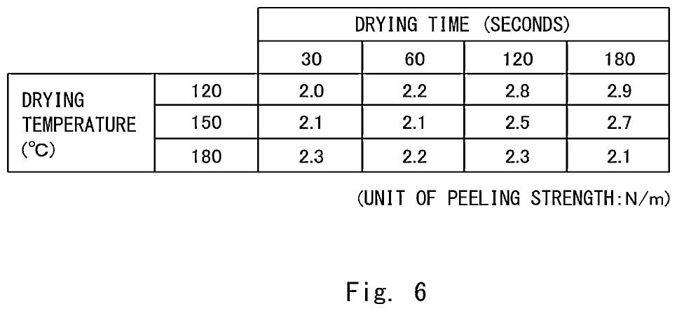

Next, the effect of the drying conditions in the drying step on the peeling strength of the mixture layer 20 was studied with reference to FIG. 6. FIG. 6 is a table showing the result of examining the effect of drying conditions on the peeling strength of the current collecting foil from the mixture layer constituting the electrode plate.

FIG. 6 shows the drying conditions and peeling strength of the positive electrode plate using the acid treated CNTs among the positive electrode plates described with reference to FIG. 4. More specifically, FIG. 6 shows the result of the study carried out in the drying step when the mixture layer 20 including the binder in the ratio of 0.75 mass % was formed on the front surface of the current collecting foil 10. In the drying step, the paste coated to the current collecting foil 10 was dried under various drying conditions (drying temperature and drying time) shown in FIG. 6 by hot air. For the twelve types of positive electrode plates thus obtained, the peeling strength was measured according to the same peeling strength measuring method as described above.

As a result of measuring the peeling strength, it was found that a positive electrode plate having an excellent peeling strength of 2.5 N/m or more was obtained under a drying condition in which the drying temperature was 150° C. or less and the drying time was 120 seconds or longer was applied.

Therefore, among the positive electrode plates obtained by the drying conditions shown in FIG. 6, two types of positive electrode plates obtained under different drying conditions were extracted, and the chemical bonding states of the elements present near the front and rear surfaces (front and rear parts) of the mixture layer 20 were examined. The result of the examination is explained below.

The two types of positive electrode plates used to examine the bonding state are the positive electrode plate having a peeling strength of 2.2 N/m and the positive electrode plate having a peeling strength of 2.8 N/m shown in FIG. 6. Further, a positive electrode plate with a peeling strength of 2.2 N/m was defined as a sample No. 1 and a positive electrode plate with a peeling strength of 2.8 N/m was defined as a sample No. 2, to observe the front and rear surfaces of the mixture layer 20 included in each sample by XPS.

Note that the sample No. 1 is a positive electrode plate obtained under a drying condition of a drying temperature of 180° C. and a drying time of 60 seconds. The sample No. 2 is a positive electrode plate obtained under a drying condition of a drying temperature of 120° C. and a drying time of 120 seconds.

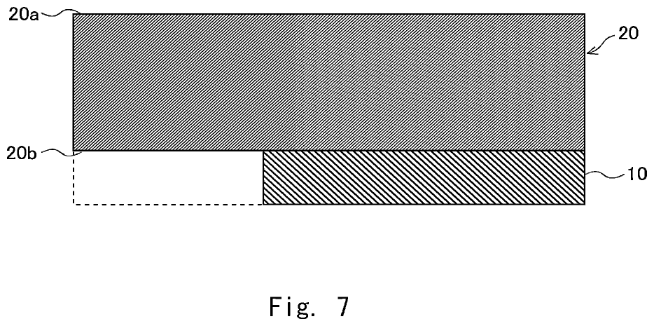

The bonding state was evaluated by determining the total amount of the carboxy groups and carbonyl groups derived from the surface functional groups in the vicinity of the front and rear surfaces of the mixture layer 20 in each sample. A method for determining the amount of functional groups will be described with reference to FIG. 7. FIG. 7 is a cross-sectional view for explaining a method for determining the amount of functional groups present near the front and rear surfaces of the mixture layer.

In determining the amount of functional groups, a layer having a thickness of 3 μm from the front surface of the mixture layer 20 in each sample was defined as a front part 20a, and the mixture layer 20 was observed from the surface side by XPS. As for a rear part 20b, which is a layer having a thickness of 3 μm from the rear surface of each sample, after a part of the current collecting foil 10 was peeled from the mixture layer 20, the exposed part of the rear part 20b from the rear surface side of the mixture layer 20 was observed by XPS.

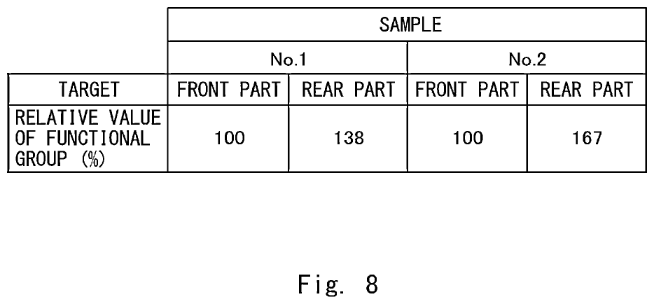

Furthermore, based on the amount of functional groups determined by XPS for the front part 20a and the rear part 20b of the sample, the amount of functional groups when the amount of functional groups in the front part 20a of the sample No. 1 is defined as 100% was calculated as a relative value. The results are shown in FIG. 8. FIG. 8 is a table showing the results of examining the amount of functional groups present near the front and rear surfaces of the mixture layer.

As shown in FIG. 8, each sample had more functional groups in the rear part 20b than in the front part 20a. Specifically, in the sample No. 1, the amount of functional groups in the rear part 20b was 1.38 times the amount of functional groups in the front part 20a. Also, in the sample No. 2, the amount of functional groups in the rear part 20b was 1.67 times the amount of functional groups in the front part 20a. That is, it was confirmed that more functional groups derived from the surface functional groups in the positive electrode plate were present in the rear part 20b of the mixture layer 20 than in the front part 20a of the mixture layer 20.

As can be seen from the results shown in FIGS. 6 and 8, when the paste coated to the front surface of the current collecting foil 10 is heated and dried with a thermal history passing through a temperature region below the boiling point of the solvent, it takes time for the solvent to volatilize, so that a sufficient reaction time for reaction between the reactive functional groups and the surface functional groups can be ensured. It is believed that this facilitates the reaction and increases the amount of functional groups formed by bonding the reactive functional groups and the surface functional groups to each other.

As described above, the electrode for a secondary battery according to this embodiment includes the current collecting foil 10 having reactive functional groups on a front surface, and the mixture layer 20 formed on the surface of the current collecting foil 10 and including the active material 31, the binder, and the CNTs 32 having surface functional groups reactive with the reactive functional groups. In the electrode for a secondary battery, in the thickness direction orthogonal to the surface of the current collecting foil 10, when the end surface of the mixture layer 20 in contact with the current collecting foil 10 is defined as the rear surface and the end surface opposite to the rear surface is defined as the front surface, more functional groups derived from the surface functional groups are present near the rear surface of the mixture layer 20 than near the front surface of the mixture layer 20.

With such a configuration, the reactive functional groups react with the surface functional groups to be chemically bonded thereto. In the electrode plate 1 in which the CNTs 32 are chemically bonded to the current collecting foil 10 by this reaction, high peeling strength can be obtained even if the amount of the binder is reduced. In the secondary battery including the electrode plate 1, the internal resistance is reduced as the amount of binder used is reduced, and as a result, a high output characteristic can be achieved.

Further, the reactive functional groups may include a hydroxyl group and the surface functional group may include a carboxy group. In this configuration, a covalent bond is formed by the reaction of a hydroxyl group with a carboxy group. In the electrode plate 1 in which the current collecting foil 10 and the CNT 32 are firmly bonded via covalent bonding, the peeling strength of the current collecting foil 10 from the mixture layer 20 is improved. Since the hydroxyl groups of the current collecting foil 10 and the carboxy groups of the CNTs 32 can be easily increased by using various methods, the amount of the surface functional groups of the CNTs 32 bonded to the reactive functional groups of the current collecting foil 10 can be increased. Thus, the binding property between the current collecting foil 10 and the CNTs 32 can be improved.

Further, the amount of functional groups included in the vicinity of the rear surface of the mixture layer 20 may be 1.3 times or more, or 1.6 times or more, of the amount of functional groups included in the vicinity of the front surface of the mixture layer 20. As the amount of functional groups included in the vicinity of the rear surface of the mixture layer 20 increases, the effect of improving the binding property due to the bonding between the current collecting foil 10 and the CNT 23 is further increased.

Furthermore, the amount of the surface functional groups is preferably 0.1 mass % to 30 mass %, and particularly preferably 1.0 mass % to 5.0 mass % based on the mass of the CNTs 32. With such a configuration, it is possible to improve the binding property between the current collecting foil 10 and the CNTs 32 without impairing the conductivity, mechanical properties, and dispersibility of the CNTs 32.

According to the method for manufacturing the electrode for a secondary battery of this embodiment, it is possible to manufacture the electrode for secondary battery that achieves the above effect.

The method for manufacturing an electrode for a secondary battery according to this embodiment includes: coating a paste including the active material 31, the binder, the CNTs 32 including surface functional groups reactive with reactive functional groups, and a solvent on a front surface of the current collecting foil 10 including the reactive functional groups on its front surface; and heating and drying the coated paste to cause the reactive functional groups to react with the surface functional groups to form a mixture layer 20.

The method for manufacturing the electrode for a secondary battery according to this embodiment includes a functional group introduction step of increasing the amount of at least one of the surface functional groups and the reactive functional groups by subjecting at least one of the CNTs 32 and the current collecting foil 10 to a surface treatment before the coating step.

In some embodiments, the reactive functional group includes hydroxyl groups and the surface functional group includes carboxy groups.

In the drying step, the coated paste may be heated and dried at a temperature of 150° C. or less for 100 seconds or longer. In this drying step, the paste coated to the front surface of the current collecting foil 10 is heated and dried with a thermal history passing through a temperature region below the boiling point of the solvent to promote the reaction between the reactive functional groups and the surface functional groups, and the amount of CNTs 32 bonded to the current collecting foil 10 can be efficiently increased. Thus, the binding property between the current collecting foil 10 and the CNT 32 can be further improved.

Therefore, according to this embodiment, it is possible to provide an electrode for a secondary battery having high durability while reducing the internal resistance of the battery, and a method for manufacturing the electrode for a secondary battery.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

1. An electrode for a secondary battery comprising:
a current collecting foil including reactive functional groups on a front surface; and
a mixture layer formed on the front surface of the current collecting foil and including an active material, a binder, and carbon nanotubes including surface functional groups reactive with the reactive functional groups,
wherein in a thickness direction orthogonal to the front surface of the current collecting foil, when an end face of the mixture layer in contact with the current collecting foil is defined as a rear surface of the mixture layer and an end face opposite to the rear surface is defined as a front surface of the mixture layer, more functional groups derived from the surface functional groups are present in a rear part having a first predetermined thickness from the rear surface of the mixture layer than in the vicinity of the a front part having a second predetermined thickness from the front surface of the mixture layer.

2. The electrode for the secondary battery according to claim 1, wherein
the reactive functional groups include a hydroxyl group and the surface functional groups include a carboxy group.

3. The electrode for the secondary battery according to claim 1, wherein
when an amount of functional groups derived from the surface functional groups is defined as an amount of the functional groups,
the amount of the functional groups included at the rear part of the mixture layer is 1.3 times or more of the amount of the functional groups included at the front part of the mixture layer.

4. The electrode for the secondary battery according to claim 1, wherein
when an amount of the functional groups derived from the surface functional groups is defined as an amount of the functional groups, and
the amount of the functional groups included at the rear part of the mixture layer is 1.6 times or more of the amount of the functional groups included at the front part of the mixture layer.

5. The electrode for the secondary battery according to claim 1, wherein
an amount of the surface functional groups is 0.1 to 30 mass % based on a mass of carbon nanotubes.

6. The electrode for the secondary battery according to claim 1, wherein
an amount of the surface functional groups is 1.0 to 5.0 mass % based on a mass of carbon nanotubes.

7. A method for manufacturing an electrode for a secondary battery comprising:
coating a paste including an active material, a binder, carbon nanotubes including surface functional groups reactive with reactive functional groups, and a solvent on a front surface of a current collecting foil including the reactive functional groups on the front surface; and
heating and drying the coated paste to cause the reactive functional groups to react with the surface functional groups to form a mixture layer.

8. The method for manufacturing the electrode for a secondary battery according to claim 7, further comprising:
increasing the amount of at least one of the surface functional groups and the reactive functional groups by subjecting at least one of the carbon nanotubes and the current collecting foil to a surface treatment before the coating of the paste.

9. The method for manufacturing the electrode for a secondary battery according to claim 7, wherein
the reactive functional groups include a hydroxyl group and the surface functional groups include a carboxy group.

10. The method for manufacturing the electrode for a secondary battery according to claim 9, wherein
in the drying, the coated paste is heated and dried at a temperature of 150° C. or less for 100 seconds or longer.
